(19) United States
(12) Patent Application Publication
(10) Pub. No.: US 2008/0237486 A1
(43) Pub. Date: Oct. 2, 2008

(54) Substrate Handling Device for a Charged Particle Beam System

(75) Inventor: Tao Zhang, Cambridge (GB)

Correspondence Address: STROOCK & STROOCK & LAVAN LLP, 180 MAIDEN LANE, NEW YORK, NY, 10038, US

(73) Assignee: NANOBEAM LIMITED, Cambridge Cambridgeshire (GB)

(21) Appl. No.: 10/550,077

(22) PCT Filed: May 13, 2005
(86) PCT No.: PCT/GB2005/050067

§ 371 Date: May 30, 2008

(30) Foreign Application Priority Data
Jun. 15, 2004 (GB) 0413357.5

(51) Int. Cl. G01N 23/00

(52) U.S. Cl. 250/491.1

(57) ABSTRACT

An electron beam lithography system includes a main chamber (4) and the exchange chamber (5) connected by a gate valve (7). A robot (15) is used to transfer a chuck (8) carrying a semiconductor wafer between a cassette (10) and laser interferometer mirror assembly (13). The robot includes a bar (17) and a side member (18) extending laterally from the bar for supporting the chuck.

### FIELD OF THE INVENTION

The present invention relates to a substrate handling device for a charged particle beam system.

The present invention seeks to provide a substrate handling device for a charged particle beam system.

### SUMMARY OF THE INVENTION

According to an aspect of the present invention there is provided a charged particle beam system including a main chamber, an exchange chamber and a substrate handling device mounted inside the main chamber for loading and unloading a substrate into and out of the main chamber, the device comprising a bar and a side member extending laterally from the bar for supporting the substrate to one side of the bar and means for translating the bar along its longitudinal axis and configured such that the side member is moveable into and out of the exchange chamber.

By supporting the substrate generally to the side of the bar and not in front of it, the substrate handling device may be compact and housed inside the main chamber. Furthermore, the main chamber need not be substantially enlarged to accommodate the substrate handling device. Thus, the size of the charged particle beam system can be minimised.

The substrate may be supported by a substrate support and the side member may be configured to support the substrate support. The substrate may be a workpiece or specimen. For example, the substrate may be a wafer, a part of a wafer or a mask. The substrate may include at least one layer overlying a base. The substrate may include at least two layers, a first layer overlying a base and a second layer overlying the first layer. The layer may be an expitaxial layer. The substrate may be patterned. The substrate may be a mask blank. The substrate may be coated with a resist layer.

The means for translating the bar may include a rail protruding from the bar. The rail may run along the bar. The means for translating the bar may further include a set of linear bearings for holding the rail.

The bar may be cogged to provide a rack. The means for translating the bar may further include a pinion arranged to engage the rack. The pinion may be directly coupled to a motor.

The device may further comprise means for supporting the bar. The means for supporting the bar may be moveable, for example up and down. The device may further comprise means for translating the bar along its transverse axis, for example for raising and lowing the bar.

The side member may be in the form of a cantilevered wing.

The device may be mounted to an inside wall of a chamber. The device may be configured to retractably project the bar and the side member through an aperture in a wall of a chamber. The substrate may be supported by a substrate support and the side member may support the substrate support. The device may be configured to exchange the substrate between first and second chambers.

The device may be configured to cooperate with a cassette having at least one shelf, the shelf having a ledge around a space, the device may be configured to permit the side member to pass through the space when the side member is raised or lowered so as to permit the substrate to be deposited on or picked up from the shelf.

The system may further comprise a cassette for holding a plurality of substrates. The cassette may comprise a plurality of shelves. Each shelf may be configured to provide a ledge around a space through which the side member can pass when being raised or lowered through the plane of the shelf. A portion of an inner periphery of each shelf may have a complementary shape to a portion of an outer periphery of the side member. The plurality of substrates may be supported by respective substrate supports.

According to another aspect of the present invention there is provided a substrate handling device for a charged particle beam system, the device comprising a bar and a side member extending laterally from the bar for supporting a substrate to one side of the bar and means for slidably moving the bar along its longitudinal axis.

According to yet another aspect of the present invention there is provided a substrate handling device comprising a bar and a side member extending laterally from the bar for supporting a substrate to one side of the bar, the bar being configured to translate along its longitudinal axis. The bar may be substantially horizontal.

According to still another aspect of the present invention there is provided a method of handling a substrate in a charged particle beam system using a device comprising a bar and a side member extending laterally from the bar for supporting a substrate to one side of the bar and means for translating the bar along its longitudinal axis, the method comprising translating the bar along its longitudinal axis.

The method may further comprise raising the bar so as to cause a substrate to be picked up. The method may further comprise lowering the bar so as to cause a substrate to be placed down. The method may comprise positioning the side member over or under a shelf.

### BRIEF DESCRIPTION OF THE DRAWINGS

An embodiment of the present invention will now be described, by way of example, with reference to the accompanying drawings in which:

FIG. 1 is a schematic view of an electron beam lithography system;

FIG. 2 is a perspective view of a main chamber and an exchange chamber of the electron beam lithography system shown in FIG. 1;

FIG. 3 is a detailed perspective view of a robot in accordance with the present invention;

FIG. 4 is a side view of the robot and an aperture in a wall of a chamber;

FIG. 5 is a perspective view of a shelf of a cassette and a mirror assembly when a chuck is placed on the mirror assembly;

FIG. 6 is a perspective view of a shelf of a cassette and a mirror assembly when a chuck is placed on the shelf;

FIGS. 7a to 7e are side views the chuck at a number of stages during operation of the robot; and

FIG. 8 is a schematic view of apparatus for controlling the robot.

### DETAILED DESCRIPTION OF THE INVENTION

### Electron Beam Lithography System 1

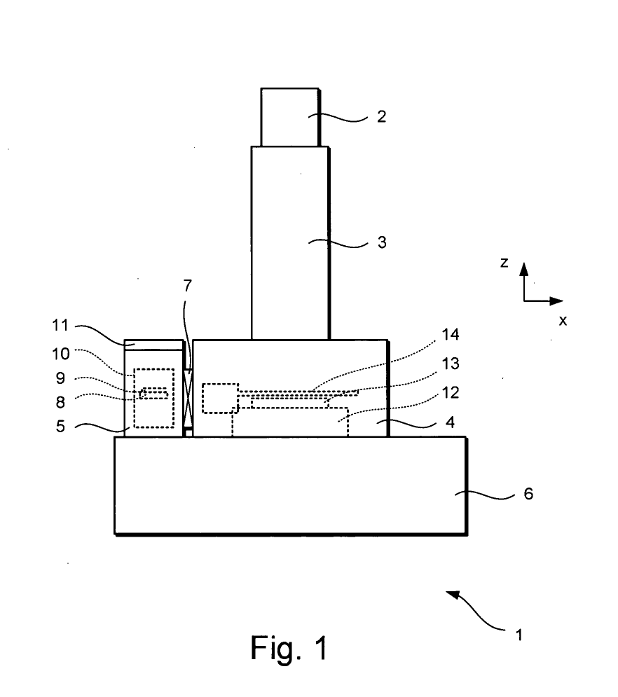

Referring to FIG. 1, an electron beam lithography system 1 is shown. The electron beam lithography system 1 includes a gun 2, a column 3, a main chamber 4, an exchange chamber 5 and a vacuum system 6.

The main chamber 4 and the exchange chamber 5 are connected by a gate valve 7. When the gate valve 7 is open, a substrate support 8, referred to herein as a chuck 8, carrying a substrate 9 can be passed between the chambers 4, 5 through the gate valve 7. The exchange chamber 5 houses a cassette 10 which can hold a plurality of chucks 8, each chuck 8 supporting a respective substrate 9. However, only one chuck 8 and one substrate 9 are shown in FIG. 1 for clarity. The exchange chamber 5 is provided with a lid 11 for allowing cassettes 10 to be switched.

In this example, the substrate 9 is a wafer, in particular a semiconductor wafer which may comprise a plurality of overlying layers (not shown), including for example semiconductor and dielectric layers at least some of which may be patterned, and coated with an electron beam resist (not shown). However, the substrate 8 may be a part of a wafer, usually referred to as a “chip”. The substrate 9 may be a mask blank, for example comprising a glass base (not shown) and an overlying metal layer (not shown) and coated with an electron beam resist (not shown). Once the mask blank is processed it can provide a mask for use in optical lithography.

When the gate valve 7 is closed, the exchange chamber 5 can be vented to atmospheric pressure and opened to allow one cassette 10 to be removed and replaced by another. Once the cassette 10 has been placed in the exchange chamber 5, the exchange chamber 5 is re-evacuated. The gate valve 7 can then be opened to permit the chuck 8 to be loaded into the main chamber 4. Thus, the main chamber 4 is not vented while the cassette 10 is replaced.

The main chamber 4 houses an x-y positioning stage 12 supporting a laser interferometer mirror assembly 13. As will be explained in more detail later, the laser interferometer mirror assembly 13 supports the chuck 8, which in turn supports the substrate 9 while the substrate 9 is exposed to an electron beam (not shown).

The main chamber 4 also houses a substrate handling device 14 in this case for loading and unloading the chuck 8 supporting a substrate 9 into and out of the chamber 4. The device 14 is usually referred to as a “robot” and is hereinafter referred to as such.

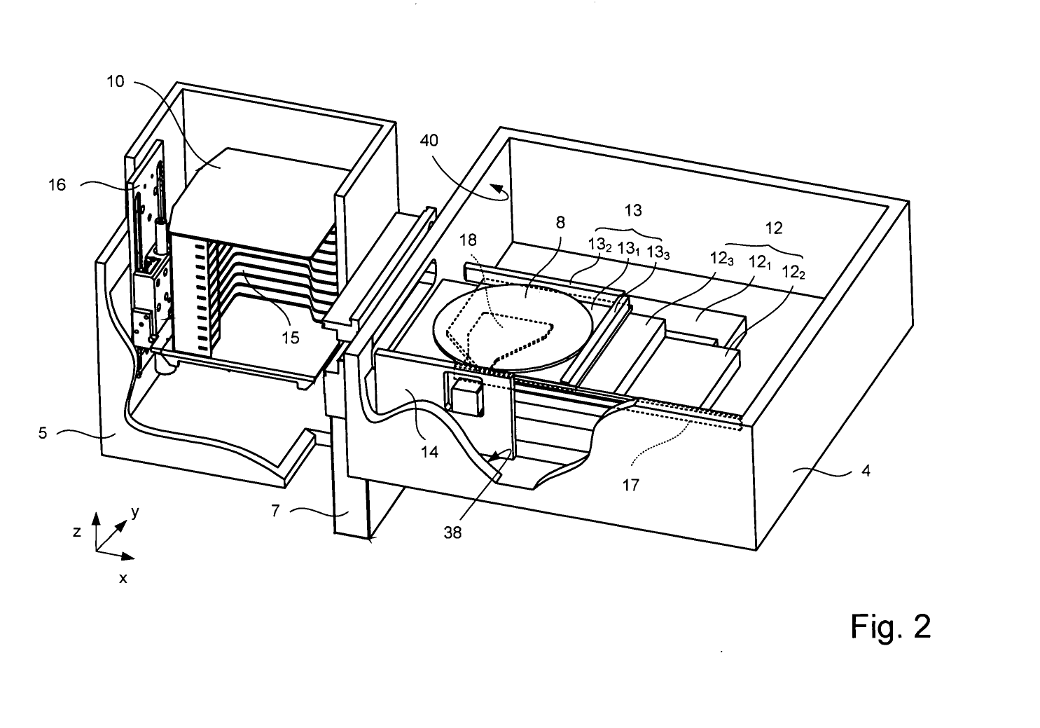

Referring to FIG. 2, the main chamber 4 and the exchange chamber 5 are shown in more detail.

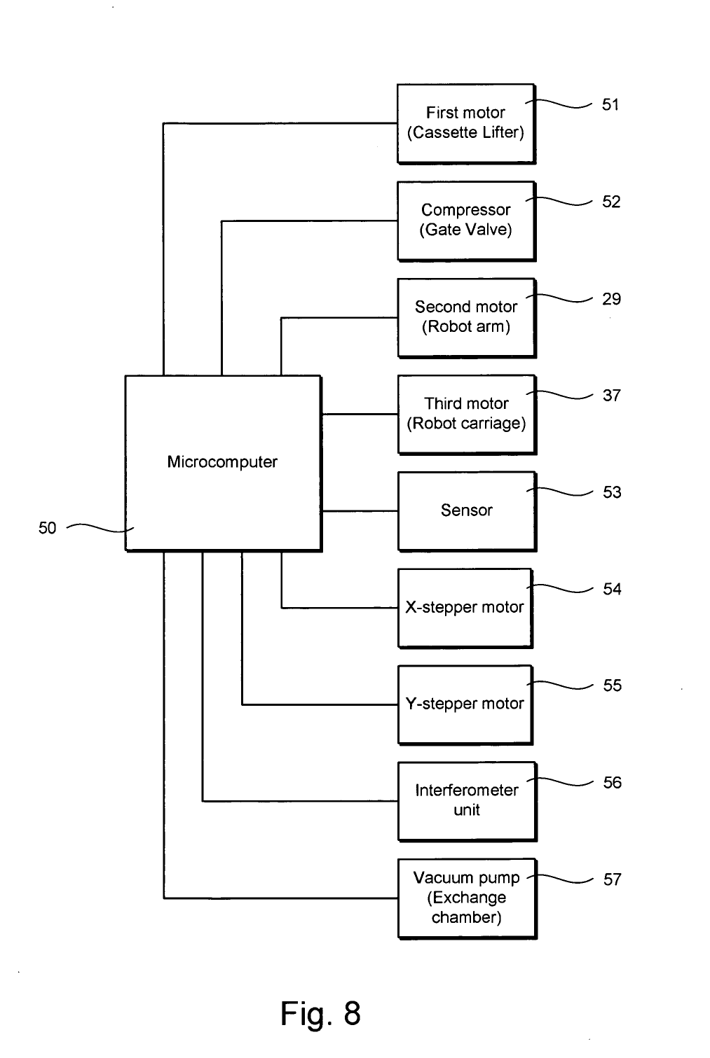

The cassette 10 has a plurality of shelves 15 for holding respective chucks (not shown). The shelves 15 are vertically stacked, in other words one shelf overlies another shelf. The cassette 10 can be raised and lowered by a lifting mechanism 16 driven by a first motor 51 (FIG. 8). The lifting mechanism 16 permits the robot 14 to access each chuck (not shown) in the cassette 10.

The x-y positioning stage 12 comprises a base 12₁ and first and second platforms 12₂, 12₃. The first platform 12₂ can move in a first orthogonal direction, for example along the y-axis, with respect to the base 12₁ and the second platform 12₃ can move in a second orthogonal direction, in this case along the x-axis, with respect to the first platform 12₂. The first and second platforms 12₂, 12₃ are driven by respective stepper motors 54, 55 (FIG. 8).

The laser interferometer mirror assembly 13 comprises a base 13₁ and first and second orthogonal mirror blocks 13₂, 13₃. The mirror assembly 13 co-operates with an interferometer unit 56 (FIG. 8) to determine the position of the mirror assembly 13 and, thus, the chuck 8. As will be explained in more detail later, the mirror assembly 13 is configured to receive and support the chuck 8. However, the mirror assembly 13 may be omitted and the x-y positioning stage 12 may be arranged to receive and to support directly the chuck 8.

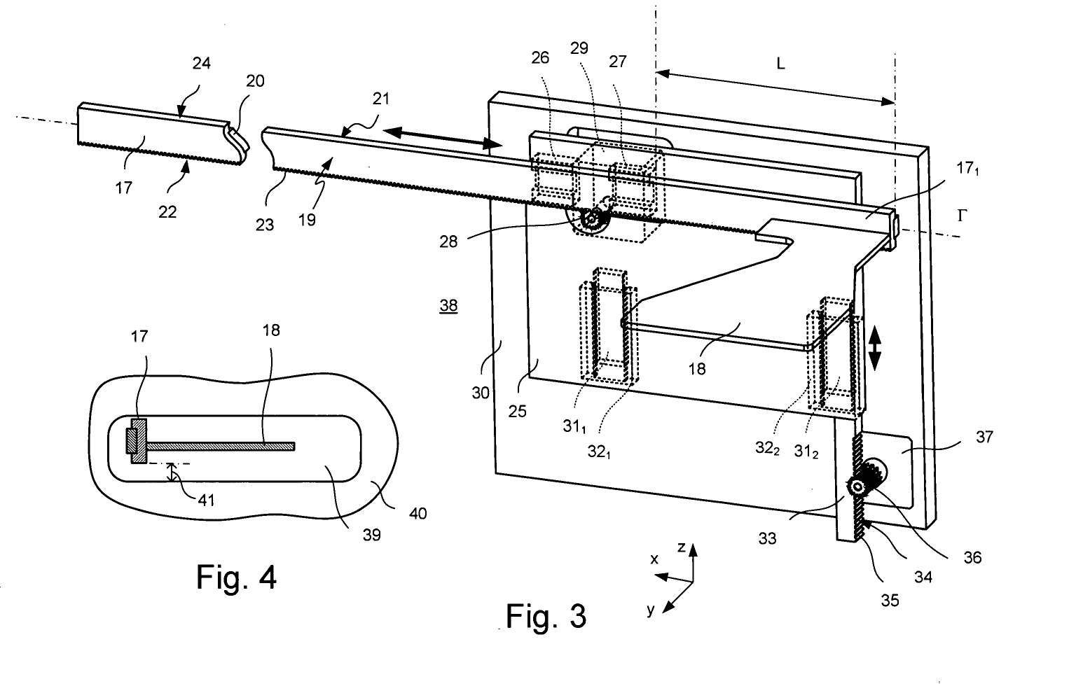

Referring to FIG. 3, the robot 14 is shown in more detail.

The robot 14 includes a bar 17 and a side member 18 extending laterally from the bar 17, in this case from a first side face 19 of the bar 17, for supporting the chuck 8 and the substrate 9 to one side of the bar 17. The side member 18 is disposed close to a first end 17₁ of the bar 17. The side member 18 is in the form of a cantilevered wing. In this case, the side member 18 is splayed. The side member 18 may be in the form of a rod having a flat plate at its distal end. The side member 18 may be in the form of two or more rods or bars to provide a fork. The side member 18 may be in the form of a frame. The side member 18 may be arranged to be higher or lower with respect to the bar 17, for example via an upstanding or depending fin. The side member 18 may be stepped. The side member 18 is formed from a metal, such as stainless steel.

The bar 17 is generally rectangular in transverse cross-section and is formed from a metal, such as stainless steel. However, the bar may be generally circular or polygonal in transverse cross-section. The bar 17 has a length, l, of about 400 mm. A rail 20 protrudes from a second side 21 of the bar 17 and runs along substantially the length of the bar 17. The bar 17 is cogged along a bottom face 22 to provide a rack 23. However, the bar 17 may be cogged along side 19, 21 or a top face 24.

The robot 14 also includes a carriage 25 for supporting the bar 17. The carriage 25 is generally laterally disposed with respect to the bar 17. The carriage 25 has a set of linear bearings 26, 27 for holding the rail 20. The rail 20 can slide along the linear bearings 26, 27 thus permitting translation of the bar 17 along its longitudinal axis Γ. The carriage 25 also has a pinion 28 coupled to a motor 29 and engaged with rack 23 for driving the bar 17 back and forth along its longitudinal axis Γ. The longitudinal axis Γ lies in a horizontal plane (x-y plane) and in this example is parallel with the x-axis. The bar 17 may be supported by the carriage 25 using other means, such as a set of wheels (not shown).

The robot 14 also includes a plate 30 for supporting the carriage 25. The plate 30 is generally laterally disposed with respect to the carriage 25. The plate 30 is provided with at least one rail, in this case a pair of rails 31₁, 31₂, which are received in respective linear bearings 32₁, 32₂ on the carriage 25. The rails 31₁, 31₂ can slide up and down in their respective linear bearings 32₁, 32₂ thus permitting transverse movement, i.e. vertical movement, of the carriage 25 and bar 17. The carriage 25 is provided with a depending post 33. The post 33 is cogged along one side 34 thus forming another rack 35. The plate 30 supports another pinion 36 which is coupled to a motor 37 and engaged with rack 35 for raising and lowering the carriage 25. A piston arrangement (not shown) may also be used. The plate 30 is mounted to an inside wall 38 of the chamber 4. The inside wall 38 may be recessed to accommodate the motor 37. The robot 14 is arranged such that the bar 17 runs parallel to the inside wall 38. The bar 17 and carriage 25 are disposed between the wall 38 of the chamber 4 and the mirror assembly 13. The other pinion 36 and motor 37 may be mounted to the wall 38 of the chamber 4.

Referring to FIG. 4, the bar 17 and side member 18 are arranged such when the bar 17 is raised and extended forwards, the bar 17 and the side member 18 pass through an aperture 39 in a wall 40 of the chamber 4 and through gate valve 7 (FIG. 2) into the exchange chamber 5 (FIG. 2). The robot 14 and chambers 4, 5 are configured such that there is clearance 41 to permit the bar 17 and the side member 18 to be lowered.

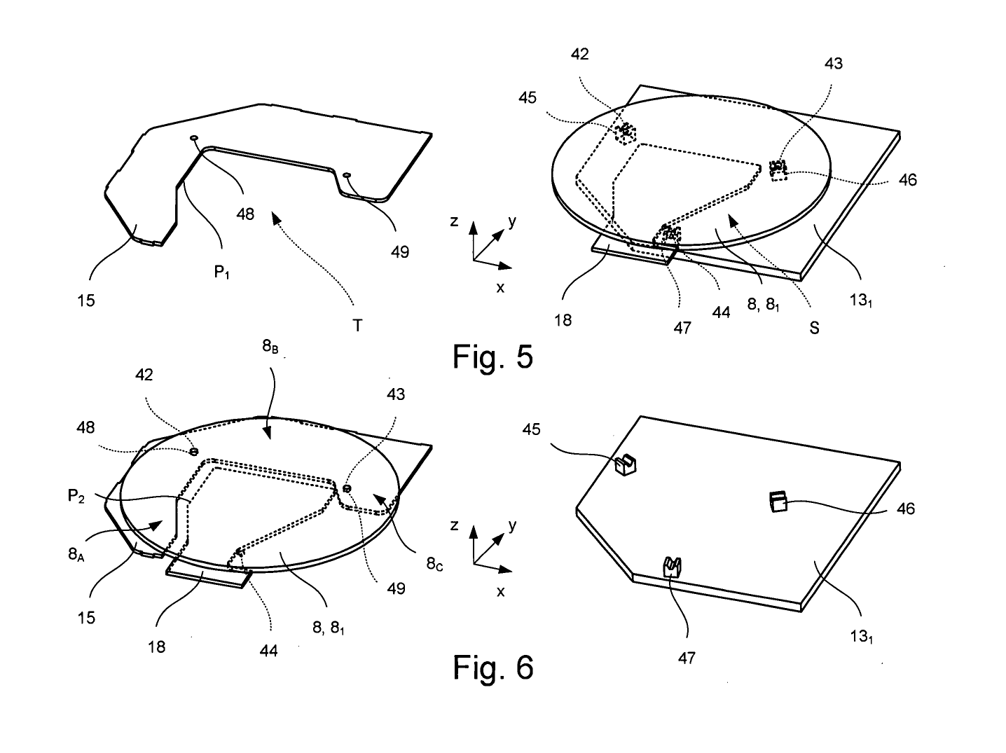

Referring to FIGS. 5 and 6, the chuck 8, the side member 18, the mirror assembly 13 and a cassette shelf 15 are shown. The mirror blocks 13₂, 13₃ (FIG. 2) and the substrate 9 (FIG. 1) have been omitted for clarity.

The chuck 8 is provided with at least three feet 42, 43, 44.

The mirror assembly 13 is provided with three blocks 45, 46, 47, upstanding from its base 13₁, for receiving the feet 42, 43, 44. Thus, when the chuck 8 is placed on the mirror assembly 13, three feet 42, 43, 44 sit on the three blocks 45, 46, 47. This provides a space S between a chuck base 8₁ and the mirror assembly base 13₁ into which the side member 18 can enter.

Each cassette shelf 15 is configured to provide a ledge around a space T through which the side member 18 can pass when being raised or lowered through the plane of the shelf 15. Each shelf 15 is arranged to support periphery portions of the chuck 8, such as portions 8_{A}, 8_{B}, 8_{C}, without the chuck 8 falling off the shelf 15. This can be achieved by each shelf 15 being shaped such that at least three parts of the shelf 15 on which the chuck 8 sits form corners of a triangle (not shown) over which the centre of mass (not shown) of the chuck 8 lies. In this case, each cassette shelf 15 is generally ‘L’-shaped in plan view. Other configurations may be used such as being generally ‘J’- or ‘C’-shaped. The shelves 15 each have a portion P₁ of an inner periphery having a complementary shape to a portion P₂ of an outer periphery of the side member 18. Each shelf 15 is also provided with two holes 48, 49 for receiving two of the three feet 42, 43, 44. Thus, when the chuck 8 is placed on a shelf 15, the chuck base 8₁ is supported directly by the shelf 15.

The cassette shelves 15 need not be a configured to provide a ledge around a central space. Instead, a shelf without a cutout, for example which may be rectangular, may be provided such that the feet 42, 43, 44 of the chuck 8 sit on the shelf 15. Thus, to pick up or put down a chuck 8, the side member 18 is inserted between a shelf 15 and the chuck 8. The shelves 15 may be provided with upstanding blocks (not shown) for receiving the feet 42, 43, 44, for example using an arrangement similar to the mirror assembly 13.

Referring again to FIG. 2, the bar 17 and the side member 18 are arranged such that the chuck 8 can be supported to the side of the bar 17 and not at the end of the bar 17, in other words not in front of bar 17. Because the robot 14 is generally disposed beside the x-y positioning stage 12 and mirror assembly 13 and not between the cassette 10 and the x-y positioning stage 12 and the mirror assembly 13, then the chuck 8 need not be rotated between it being picking up from the mirror assembly 13 and being depositing on the shelf 15. Thus, the process of loading and unloading the chuck 8 may be completed by translating the bar 17 along its longitudinal axis and by raising and lowering the bar 17. Furthermore, the space occupied by the robot 14 is reduced, which can permit a smaller chamber arrangement to be used.

### Operation

The bar 17 and the side member 18 can have a number of positions in which it may stop or rest, expressed in terms of extension length L and whether the carriage 25 is raised or lowered, and the positions are summarised in Table 1 below:

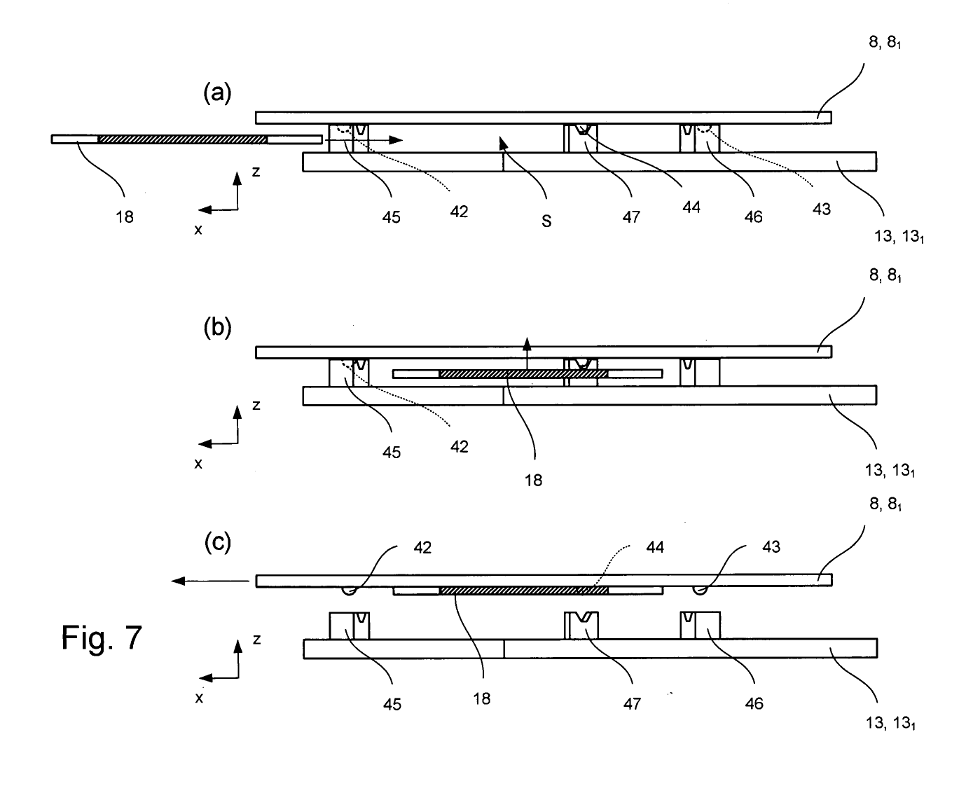

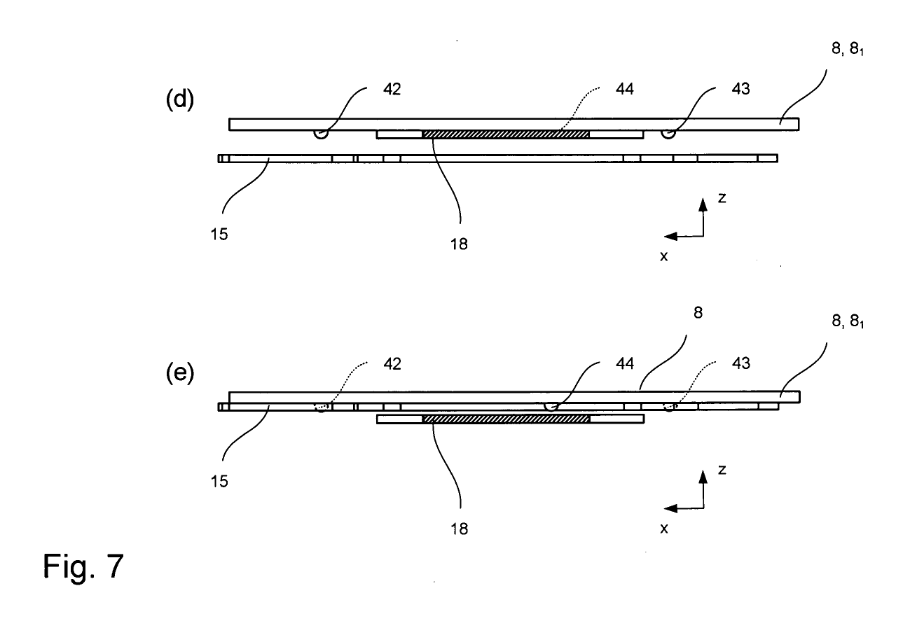

TABLE 1

| | Up | Down |
|---|---|---|
| L = L₁ | Zenith after lifting chuck | Nadir after setting down |
| | 8 lifted from shelf 15 or | chuck 8 on shelf 15 or |
| | Zenith before setting down | Nadir before lifting chuck 8 |
| | chuck 8 on shelf 15 (e.g. | from shelf 15 (e.g. FIG. 6) |
| | FIG. 7d) | |
| L = L₂ | | Waiting position while |
| | | cassette 10 is raised or |
| | | lowered |
| L = L₃ | | Waiting position while |
| | | substrate 9 is exposed |
| L = L₄ | Zenith after lifting chuck | Nadir after setting down |
| | 8 from mirror assembly 13 | chuck 8 on mirror assembly |
| | or | 13 or |
| | Zenith before setting down | Nadir before lifting up the |
| | chuck 8 on mirror assembly | chuck 8 from mirror assembly |
| | 13 (e.g. FIG. 7c) | 13 (e.g. FIG. 5) |

In Table 1, the lengths L₁, L₂, L₃, L₄ are defined from the end of the second linear bearing 27 to the end of the bar 17 and L₁>L₂≧L₃>L₄. L₄=0 can be used, although a value L₄>0 may be used so as to balance the bar 17. L₁=L₅ can be used, where L₅ is the length of the rail 20 minus the length of the linear bearings 26, 27, although a value L₁<L₅ may be used so help balance the bar 17.

Length L₂ is arranged such that the bar 17 and the side member 18 are withdrawn from the cassette 10 (FIG. 2) to permit the cassette 10 to be raised or lowered.

Length L₃ is arranged such that the bar 17 and the side member 18 remain in the main chamber 4 and permit the gate valve 7 closed. Also, length L₃ is arranged such that the bar 17 and the side member 18 do not interfere with movement of the mirror assembly 13, in particular collide with the blocks 45, 46, 47 (FIGS. 5 and 6), when the x-y positioning stage 12 (FIG. 2) is moved.

Referring to FIGS. 7a to 7e, a process of picking up the chuck 8 from the mirror assembly 13 and depositing the chuck 8 on the shelf 15 will be described.

Once the substrate 9 (FIG. 1) has been exposed, the x-y positioning stage 12 (FIG. 2) moves the mirror assembly 13 to a “load” position for the chuck 8 to be unloaded. The side member 18 begins to move in, into space S under the chuck 8, for example as shown in FIG. 7a. The side member 18 is moved by translating the bar 17 which is driven by motor 29 (FIG. 3) via the rack 23 and the pinion 28.

Once the side member 18 is moved under the chuck 8, for example as shown in FIG. 7b, the support member 18 begins to rise. The side member 18 is lifted by raising the carriage 25 (FIG. 3) which is driven by motor 37 via the other rack 35 and other pinion 36.

The side member 18 engages the base 8₁ of the chuck 8 and lifts the chuck 8 off the mirror assembly 13 until the side member 18 is clear of the blocks 45, 46, 47, for example as shown in FIG. 7c. If not already open, the gate valve 7 (FIG. 2) is opened to allow passage of the chuck 8 and substrate 9. The support member 18 then begins to move towards the cassette 10 (FIG. 2).

Once the chuck 8 reaches the cassette 10 (FIG. 2) such that it hangs over the shelf 15, for example as shown in FIG. 7d, the side member 18 begins to drop.

As the side member 18 drops, the shelf 15 engages the base 8, of the chuck 8. Thus, the side member 18 leaves the chuck 8 on the shelf 15, for example as shown in FIG. 7e.

The side member 18 is withdrawn. The cassette 10 (FIG. 2) can be raised to access another shelf (not shown) and another chuck (not shown) supporting another substrate (not shown).

A process of picking up the chuck (not shown) from the shelf (not shown) and depositing the chuck (not shown) on the mirror assembly 13 comprises reversing the order of the steps and the directions of travel just described.

Once the chuck 8 and substrate 9 are within the main chamber 4, the gate valve 7 (FIG. 2) may be closed.

Referring to FIG. 8, the process of loading and unloading chucks is controlled by a controller in the form of a microcomputer 50.

The microcomputer 50 controls a motor 51 for driving the cassette lifting mechanism 16 (FIG. 2), a compressor 52 for pneumatically driving the gate valve 7 (FIG. 2) and the motor 29 (FIG. 3) for driving the bar 17 (FIG. 3) back and forth, the motor 37 for raising and lowing the carriage 25 (FIG. 3).

The microcomputer 50 may receive signals from a set of sensors 53 for determining the position of the bar 17 (FIG. 3), carriage 25 (FIG. 3) and gate valve 7 (FIG. 2). The microcomputer 50 may also control the stepper motors 54, 55 for driving the x-y positioning stage 12 (FIG. 2) and receive signals from an interferometer unit 56 for determining the position of the mirror assembly 13 (FIG. 2). The microcomputer 50 can also control operation of a vacuum pump and valves 57 for evacuating and venting the exchange chamber 4.

It will be appreciated that many modifications may be made to the embodiment hereinbefore described. The robot may handle the substrate directly without a chuck. The robot may load and unload a substrate into an ion beam system. The substrate may be a specimen to be inspected in an electron- or ion-beam analysis machine, such as a scanning electron microscope. The robot need not load substrate into a chamber. The main chamber may be provided with means for controlling an environment in the chamber, such as apparatus for delivering dry air or nitrogen into the chamber. The protruding rail may be omitted and the bar may be supported by a linear bearing.

1. A charged particle beam system including a main chamber, an exchange chamber and a substrate handling device mounted inside the main chamber for loading and unloading a substrate into and out of the main chamber, the device comprising a bar having a longitudinal axis and a side member extending laterally from the bar for supporting the substrate to one side of the bar, the bar mounted for movement along the longitudinal axis between at least a first position, in which the side member is located within the exchange chamber and a second position in which the side member is located outside the exchange chamber.

2. A system according to claim 1, wherein the device further comprises means for translating the bar, the translating means including a rail protruding from the bar.

3. A system according to claim 2, wherein the rail runs along the bar.

4. A system according to claim 2, wherein the means for translating the bar further includes a set of linear bearings for holding the rail.

5. A system according to claim 1, wherein the bar is cogged to provide a rack.

6. A system according to claim 5, wherein the device further comprises means for translating the bar, wherein the means for translating the bar further includes a pinion arranged to engage the rack.

7. A system according to claim 6, wherein the pinion is directly coupled to a motor.

8. A system according to claim 1, wherein the device further comprises means for supporting the bar.

9. A system according to claim 8, wherein the device further comprises means for translating the bar, the means for translating the bar including a rail protruding from the bar and wherein the means for supporting the bar includes a set of linear bearings for holding the rail.

10. A system according to claim 8, wherein the bar is cogged to provide a rack and the means for supporting the bar includes a pinion arranged to engage the rack.

11. A system according to claim 1, wherein the bar has a transverse axis, the device further comprising means for translating the bar along the transverse axis.

12. A system according to claim 11, wherein the means for translating the bar along the transverse axis comprises means for raising and lowering said the bar.

13. A system according to claim 1, wherein the side member is in the form of a cantilevered wing.

14. A system according to claim 1, wherein the main chamber has an inside wall and the device is mounted to the inside wall.

15. A system according to claim 1, wherein the main chamber has a wall having an aperture and the bar and the side member project through the aperture in the wall of the main chamber.

16. A system according to claim 1, wherein the bar is substantially horizontal.

17. A system according to claim 1, further comprising a cassette having a plurality of shelves.

18. A system according to claim 1, further comprising a cassette having at least one shelf, the shelf having a ledge around a space, the side member movable through the space when the side member is raised or lowered so as to permit the substrate to be deposited on or picked up from the shelf.

19. A system according to claim 1, wherein the device further comprises a substrate support, the and side member supporting the substrate support.

20. A system according to claim 1, wherein the substrate is a workpiece.

21. A system according to claim 1, wherein the substrate is a wafer.

22. A system according to claim 1, wherein the substrate is a wafer chip.

23. A system according to claim 21, wherein the substrate includes at least one layer overlying a base.

24. A system according to claim 23, wherein the substrate that includes at least two layers, a first layer overlying a base and a second layer overlying the first layer.

25. A system according to claim 23, wherein the one layer is an expitaxial layer.

26. A system according to claim 21, wherein the substrate is patterned.

27. A system according to claim 1, wherein the substrate is a mask blank.

28. A system according claim 1, wherein a surface of the substrate is coated with a resist layer.

29. A system according to claim 1, wherein the substrate is a specimen.

30. A system according to claim 1, further comprising a cassette for holding a plurality of wafers, the side member engageable with at least one of the plurality of wafers.

31. A system according to claim 30, wherein the cassette comprises a plurality of shelves.

32. A system according to claim 31, wherein each shelf includes a ledge defining a plane and around a space through which the side member can pass when being raised or lowered through the plane of the shelf.

33. A system according to claim 31, wherein a portion of an inner periphery of each shelf has a complementary shape to a portion of an outer periphery of the side member.

34. A system according to claim 30, further comprising wafer sup orts wherein the wafers are supported by respective wafer supports.

35. A system according to claim 1, wherein in a thirds position, the device is contained within the main chamber.

36. A system according to claim 1, further comprising means for evacuating the main chamber.

37. A system according to claim 1, further comprising means for controlling an environment within the main chamber.

38. A substrate handling device for a charged particle beam system, the device comprising a bar and a side member extending laterally from the bar for supporting a substrate to one side of the bar and means for slidably moving the bar along its longitudinal axis.

39. A substrate handling device for a charged particle beam system, the device comprising a bar and a side member extending laterally from the bar for supporting a substrate to one side of the bar, the bar being configured to translate along its longitudinal axis.

40. A method of handling a substrate in a charged particle beam system using a device comprising a bar having a longitudinal axis and a side member extending laterally from the bar for supporting the substrate to one side of the bar, the method comprising:
translating the bar along the longitudinal axis.

41. A method according to claim 40, further comprising:
raising the bar so as to cause a substrate to be picked up.

42. A method according to claim 40, further comprising:
lowering the bar so as to cause the substrate to be placed down.

43. A substrate handling device for a charged particle beam system, for use with a substrate the device comprising:
a bar having a longitudinal axis and a side member extending laterally from the bar for supporting the substrate to one side of the bar; and
means for translating the bar along the longitudinal axis.
